(19) United States
(12) Patent Application Publication
(10) Pub. No.: US 2019/0219051 A1
(43) Pub. Date: Jul. 18, 2019

(54) SUCTION MANIFOLD FOR HYDRAULIC FRACTURING PUMP

(71) Applicant: KCF TECHNOLOGIES, INC., State College, PA (US)

(72) Inventors: David R. KRAIGE, State College, PA (US); Jeremy E. FRANK, Pine Grove Mills, PA (US); Gary H. KOOPMANN, Alexandria, VA (US); Blake T. BONFANTI, Argyle, TX (US)

(73) Assignee: KCF TECHNOLOGIES, INC., State College, PA (US)

(21) Appl. No.: 16/248,728

(22) Filed: Jan. 15, 2019

Related U.S. Application Data
(60) Provisional application No. 62/617,599, filed on Jan. 15, 2018.

(51) Int. Cl. F04B 53/16; E21B 41/00; E21B 43/26; F16L 41/03

(52) U.S. Cl. CPC F04B 53/16; E21B 41/00; F04B 15/00; F16L 41/03; E21B 43/26

(57) ABSTRACT

A suction manifold for providing fluid flow to a pump for hydraulic fracturing includes an input port configured to receive a flow of fluid from a source, a plurality of output ports configured to direct the flow of fluid to a plurality of corresponding cylinders of the pump, and a chamber configured to direct the flow of fluid from the input port to the output ports. The input port is configured to direct the flow of fluid in a direction parallel to a direction in which the output ports direct the flow of fluid.

### CROSS-REFERENCE TO RELATED APPLICATION

This nonprovisional application claims the benefit of U.S. Provisional Application No. 62/617,599, filed Jan. 15, 2018. The disclosure of the prior application is hereby incorporated by reference herein in its entirety.

### TECHNICAL FIELD

This disclosure relates to high pressure pumps such as, for example, hydraulic fracturing pumps. More particularly, the disclosure relates to a suction manifold for such hydraulic fracturing pumps.

### BACKGROUND

Hydraulic fracturing is often used to produce oil and gas in an economic manner from low permeability reservoir rocks. Hydraulic fracturing increases rock permeability by opening channels through which hydrocarbons can flow to recovery wells. During hydraulic fracturing, a fluid carrying proppants in suspension is pumped into the earth under high pressure where it enters a reservoir rock and fractures it, thereby opening and widening channels for oil and gas to flow.

Specialized positive-displacement piston pumps are used to develop the pressures necessary for hydraulic fracturing or “fracking.” These pumps typically include fluid ends within the body of which reciprocating plungers place fluids under pressure and valves control fluid flow to and from the plungers. These pumps also include a suction manifold that provides a flow of fluid to the body of the fluid end.

Positive-displacement piston pumps suffer from cavitation when exposed to poor suction conditions on the inlet side of the pump. Chronic cavitation of a pump leads to an extreme reduction in its service life, and can cause extremely early component failure, possibly leading to external leaks and safety concerns with uncontained high-pressure fluid. Hydraulic equipment industry guidelines exist for providing proper suction piping to the inlet of a positive-displacement pump to avoid this issue; however, practical concerns frequently make it difficult for the suction piping to adhere to these ideal guidelines. For example, the five-cylinder pumps used in natural gas well hydraulic fracturing are a prime example of this sub-optimal suction piping. Since all of the fracking assets must be mobile in order to move from one well site to another, the pumps and associated suction and discharge plumbing are built onto highway vehicle trailers, which of course present very restrictive dimensions for packaging the piping.

Because the pump itself takes up virtually the entire allowable trailer width, there is very little space for the suction piping to be run into the pump in a symmetrical fashion. Thus, typical suction manifolds for hydraulic fracturing pipes come in from the rear end of the pump, in line with the trailer, meaning the inlet to the manifold is very close to the cylinder at the tail end of pump, but very far away from the cylinder at the opposite end of the pump. This immediately causes an asymmetry within the pump which opens up the possibility for unequal performance between the cylinders, reversing flow within the manifold, and generally poor suction conditions which can lead to cavitation of one or more cylinders of the pump.

Additionally, because of its layout, a traditional suction manifold involves a 90-degree bend of the fluid path in very close proximity to the inlet of each cylinder of the pump. This design is in direct violation of pumping standards which stipulate that there should be no bends in the suction piping less than 5-10 pipe diameters away from the pump inlet.

Finally, traditional manifolds involve extremely sharp corners for the flow to navigate, particularly in conditions where the flow is reversing in the manifold. For instance, in the case when cylinder #1 is drawing in fluid, it may pull fluid away from cylinders #2-5, opposite of the normal direction of flow through the manifold. Sharp corners in the manifold impede the motion of the fluid, again raising the risk of cavitation or pump starvation due to insufficient or inconsistent flow into the pump's inlets.

It may be desirable to provide a suction manifold for a hydraulic fracturing pump that overcomes one or more of the aforementioned problems with conventional manifolds. For example, it may be desirable to provide a suction manifold having more uniform fluid velocity throughout, allowing unimpeded fluid flow to each cylinder of the pump, and reducing the risk of cavitation and pump damage. For example, it may be desirable to provide a suction manifold that is symmetrical, thereby providing more equal flow to each of the pump's cylinders; that eliminates 90-degree bends in the vicinity of each pump inlet; that eliminates sharp corners inside the manifold; and that maintains adequate and consistent cross-sectional area on approach to each pump inlet

### SUMMARY

According to an exemplary embodiment of the disclosure, a suction manifold for providing fluid flow to a pump for hydraulic fracturing includes an input port configured to receive a flow of fluid from a source, a plurality of output ports configured to direct the flow of fluid to a plurality of corresponding cylinders of the pump, and a chamber configured to direct the flow of fluid from the input port to the output ports. The input port is configured to direct the flow of fluid in a direction parallel to a direction in which the output ports direct the flow of fluid.

In some aspects, the input port is on a first lateral side of the chamber and the output ports are on a second lateral side of the chamber opposite to the first lateral side.

According to various aspects, the output ports are spaced apart from one another in a second direction perpendicular to a flow direction through the input port.

According to some aspects, the chamber has a symmetrical configuration relative to a center of the input port in a second direction perpendicular to a flow direction through the input port.

In various aspects, the output ports are arranged symmetrical relative to the center of the input port in a second direction perpendicular to the direction in which the output ports direct the flow of fluid.

In accordance with an exemplary embodiment of the disclosure, a suction manifold for providing fluid flow to a pump for hydraulic fracturing includes an input port configured to receive a flow of fluid, a chamber configured to receive the flow of fluid via the input port, and a plurality of output ports configured to direct the flow of fluid from the chamber to a plurality of corresponding cylinders of the pump. The input port is on a first lateral side of the chamber and the output ports are on a second lateral side of the chamber opposite to the first lateral side, the output ports are spaced apart from one another in a first direction perpendicular to a flow direction through the input port, and the chamber has a symmetrical configuration in the first direction relative to a center of the input port.

In some aspects, the output ports are arranged symmetrical relative to the center of the input port.

According to various aspects, the input port is configured to direct the flow of fluid in a direction parallel to a direction in which the output ports direct the flow of fluid.

According to an exemplary embodiment of the disclosure, a pump for hydraulic fracturing includes a high pressure pump power end supported on a mobile trailer having a width, a pump fluid end operatively attached to the power end so as to provide a source of high pressure fluid for injection into an oil or gas well during a standard hydraulic fracking operation, and a suction manifold mounted to the fluid end. The suction manifold includes an inlet port configured to receive a flow of fluid and a plurality of output ports configured to direct the flow of fluid to a plurality of corresponding cylinders of the pump power end. The input port and the output ports open in a direction of the width of the mobile trailer.

In various aspects, the suction manifold further comprises a chamber configured to direct the flow of fluid from the input port to the output ports.

According to some aspects, the input port is configured to direct the flow of fluid in a direction parallel to a direction in which the output ports direct the flow of fluid.

In some aspects, the input port is on a first lateral side of the chamber and the output ports are on a second lateral side of the chamber opposite to the first lateral side.

According to various aspects, the output ports are spaced apart from one another in a second direction perpendicular to a flow direction through the input port.

According to some aspects, the chamber has a symmetrical configuration relative to a center of the input port in a second direction perpendicular to a flow direction through the input port.

In various aspects, the output ports are arranged symmetrical relative to the center of the input port in a second direction perpendicular to the direction in which the output ports direct the flow of fluid

Because of the above features, the proposed suction manifold delivers more uniform fluid velocity throughout, allowing unimpeded fluid flow to each of the pump's cylinders, thus reducing the risk of cavitation and pump damage.

### BRIEF DESCRIPTION OF THE DRAWINGS

FIG. 1 is a diagrammatic perspective view of a positive-displacement piston pump having a conventional manifold.

FIG. 2 is a diagrammatic side view of the positive-displacement piston pump having a conventional manifold.

FIG. 3 is a diagrammatic side view of the positive-displacement piston pump having a suction manifold in accordance with various aspects of the disclosure.

FIGS. 4A and 4B are diagrammatic views showing fluid flow to the positive-displacement piston pump having the suction manifold of FIGS. 1 and 2.

FIG. 5 is a diagrammatic view showing fluid flow to the positive-displacement piston pump having the suction manifold of FIG. 3.

FIG. 6 is a diagrammatic view showing the percent of time where fluid flow through the suction manifold of FIGS. 1 and 2 is below the sand fallout velocity.

FIG. 7 is a diagrammatic view showing the percent of time where fluid flow through the suction manifold of FIG. 3 is below the sand fallout velocity.

FIG. 8 is a diagrammatic view showing the percent of time where fluid flow through the suction manifold of FIGS. 1 and 2 is above the erosional velocity.

FIG. 9 is a diagrammatic view showing the percent of time where fluid flow through the suction manifold of FIG. 3 is above the erosional velocity.

### DETAILED DESCRIPTION OF EMBODIMENTS

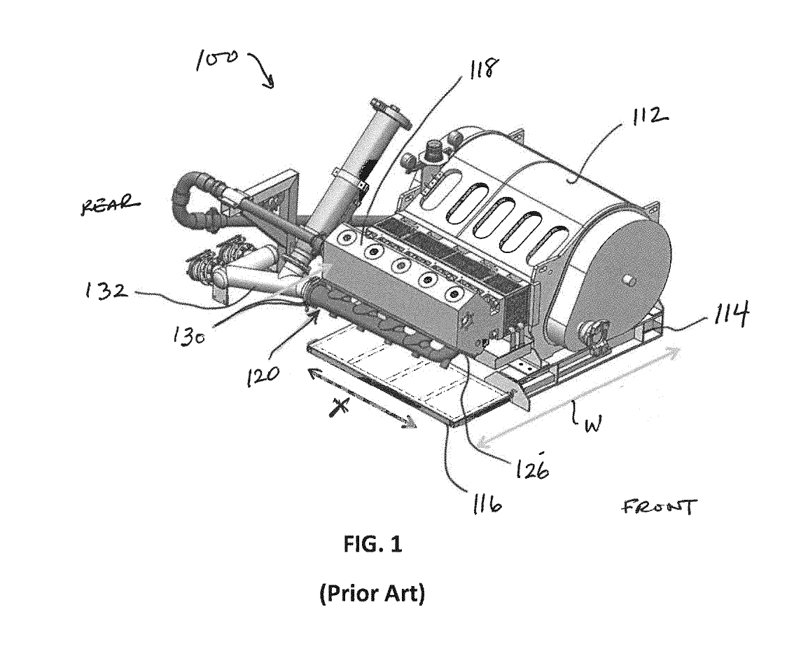

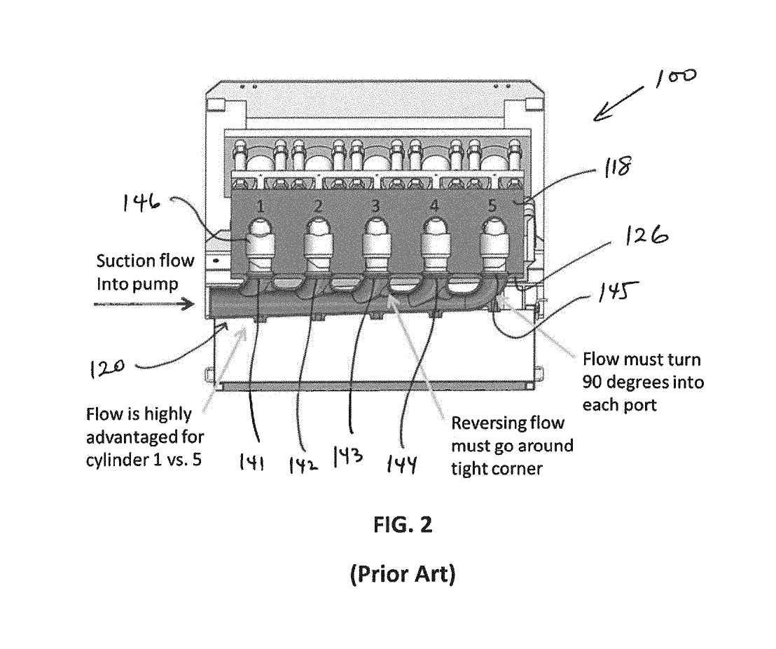

Referring to FIGS. 1 and 2, a conventional five-cylinder pump 100 for hydraulic fracturing is illustrated. The pump 100 includes a high pressure pump power end 112 mounted to a pump frame 114 which is supported on a mobile trailer 116 having a width W. The equipment mounted on the trailer cannot exceed the width W. A pump fluid end 118 is operatively attached to the power end 112 so as to provide a source of high pressure fluid for injection into an oil or gas well during a standard hydraulic fracking operation.

The pump 100 further includes a conventional suction manifold 120 that directs the fluid in a first direction X from a rear of the trailer 116 toward a front of the trailer 116. The suction manifold 120 is mounted by mounting bolts (not shown) to the fluid end 118. The bolts extend through mounting holes in the mounting plate 126 of the suction manifold 120 into mounting holes in the fluid end 118 to secure the suction manifold 120 to the fluid end 118. The suction manifold 120 includes an inlet port 130. External piping 132 is connected to the inlet port 130 in order to supply fluid to the suction manifold 120. A discharge manifold which allows for the exit of the pumped high pressure fluid is usually integral to the fluid section.

The suction manifold 120 includes five suction manifold ports 141, 142, 143, 144, 145, which are inlets to the cylinders of the pump 100. Each of the suction manifold ports 141, 142, 143, 144, 145 is fluidly coupled with a corresponding suction valve 146 of the fluid end 118, which in turn is connected with a cylinder of the pump 100. The number of ports in the suction manifold 120 is equal to the number of suction valves 146 in the pump fluid end 118 and the number of cylinders of the pump 100.

As best shown in FIG. 2, the suction manifold 120 includes bends of about 90° from a central chamber 140 of the suction manifold 120 to the suction manifold ports 141, 142, 143, 144, 145. Further, reversing flow must go around tight corners on the downstream side of the bends. Moreover, because of the sequential arrangement of the suction manifold ports 141, 142, 143, 144, 145, flow is highly advantaged at the first suction manifold port 141 versus the fifth suction manifold port 145. Thus, flow is highly advantaged for the cylinder corresponding to the first suction manifold port 141 versus the cylinder corresponding to the fifth suction manifold port 145. Indeed, flow becomes disadvantaged moving for each of the ports 142, 143, 144, 145 subsequent to the first suction manifold port.

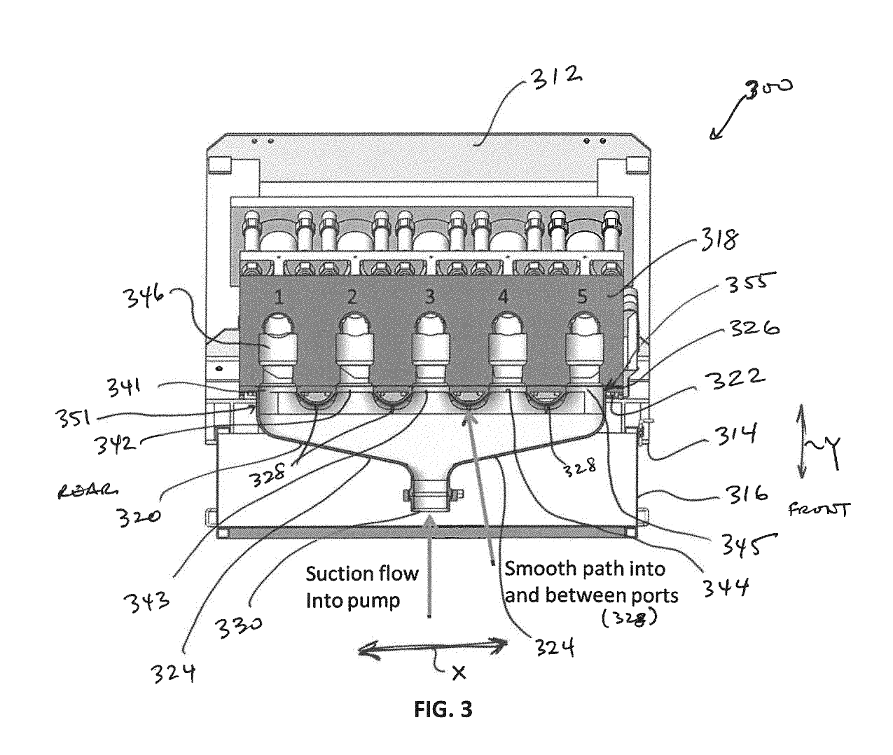

Referring now to FIG. 3, a five-cylinder positive-displacement piston pump 300 having a suction manifold in accordance with the disclosure is illustrated. As shown, the pump 300 includes a high pressure pump power end 312 mounted to a pump frame 314 which is supported on the mobile trailer 116 having a width W. A pump fluid end 318 is operatively attached to the power end 312 so as to provide a source of high pressure fluid for injection into an oil or gas well during a standard hydraulic fracking operation.

The pump 300 further includes a suction manifold 320 mounted by mounting bolts 322 to the fluid end 318. The bolts 322 extend through mounting holes in the mounting plate 326 of the suction manifold 320 into mounting holes in the fluid end 318 to secure the suction manifold 320 to the fluid end 318. The suction manifold 320 includes an inlet port 330. External piping (not shown) is connected to the inlet port 330 in order to supply fluid to the suction manifold 320.

The suction manifold 320 includes five suction manifold ports 341, 342, 343, 344, 345 spaced apart from one another in a first direction X perpendicular to the width W of the trailer 116. The suction manifold 320 directs the fluid from the inlet port 330 in the first direction X to the suction manifold ports 341, 342, 343, 344, 345. Each of the suction manifold ports 341, 342, 343, 344, 345 is fluidly coupled with a corresponding suction valve 346 of the fluid end 318, which in turn is connected with a cylinder of the pump 300. The number of ports in the suction manifold 320 is equal to the number of suction valves 346 in the pump fluid end 318 and the number of cylinders of the pump 300.

As shown in FIG. 3, the length of the suction manifold 320 in the first direction X continuously increases from the inlet port 330 to a maximum length that extends from a first end 351 at the first suction manifold port 341 to a second end 355 at the fifth suction manifold port 345. In the five-cylinder pump 300 illustrated in FIG. 3, the inlet port 330 is aligned with the third suction manifold port 343 in a second direction Y perpendicular to the first direction X, and thus the maximum width of the suction manifold 320 in the second direction is the distance from the inlet port 330 to the third suction manifold port 343. For example, the suction manifold 320 includes walls 324 extending in opposite directions from the inlet port in the first direction X. The walls 324 extend continuously outward from the inlet port 330 toward the suction manifold ports 341, 342, 343, 344, 345 at acute angles relative to the first direction X and the second direction Y. The suction manifold 320 includes smoothly curved walls 328 between adjacent pairs of suction manifold ports 341, 342, 343, 344, 345. The suction manifold 320 thus avoids bends from a central chamber 340 of the suction manifold 320 to the suction manifold ports 341, 342, 343, 344, 345.

As shown in FIG. 3, the input port 330 is on a first lateral side of the chamber 340 and the suction manifold ports 341, 342, 343, 344, 345 are on a second lateral side of the chamber 340 opposite to the first lateral side in the first direction X. The chamber 340 has a symmetrical configuration in the first direction X (i.e., perpendicular to the flow direction) relative to a center of the input port 330, and the suction manifold ports 341, 342, 343, 344, 345 are arranged symmetrical relative to the center of the input port 330 in the first direction X.

As described above, a dimension of the suction manifold 320 in a direction of flow from the input port 330 to the suction manifold ports 341, 342, 343, 344, 345 decreases from a center (at the input port 330) toward both ends 351, 355 of the suction manifold 320. The suction manifold 320 is configured such that fluid flows into the suction manifold 320 via the input port 330 in the first direction X that is substantially parallel to the flow through the suction manifold ports 341, 342, 343, 344, 345 to the pump.

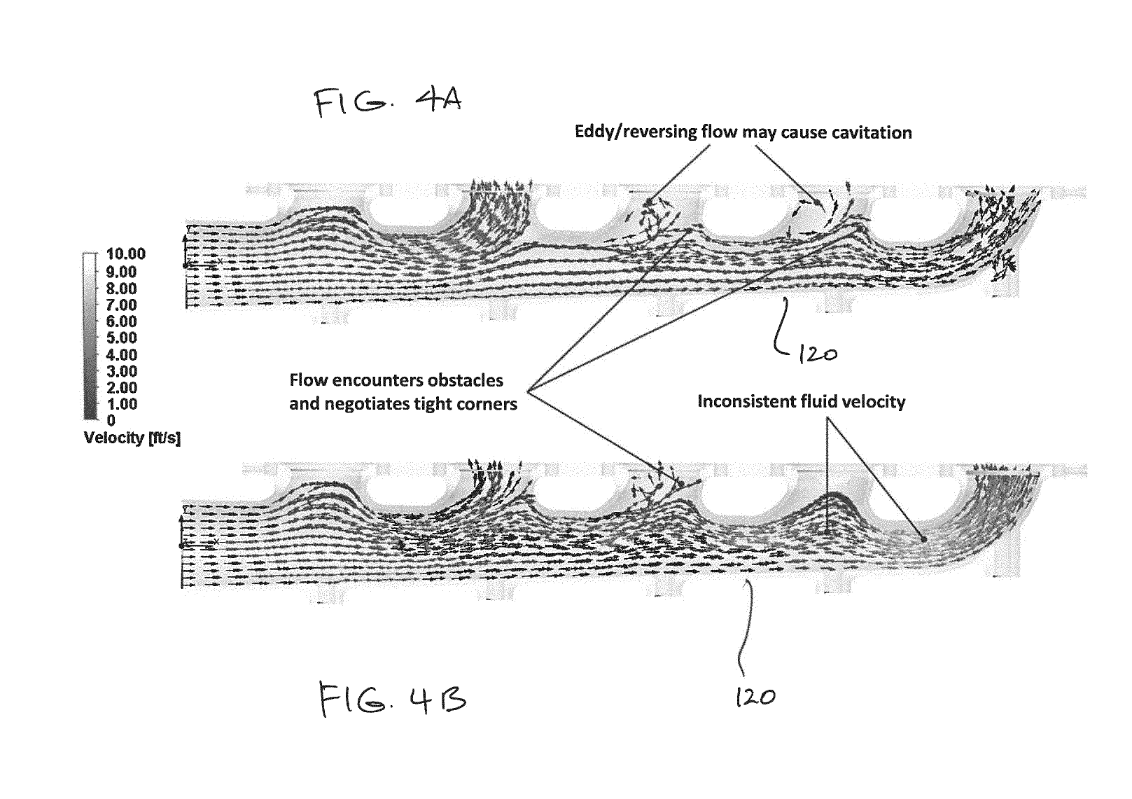

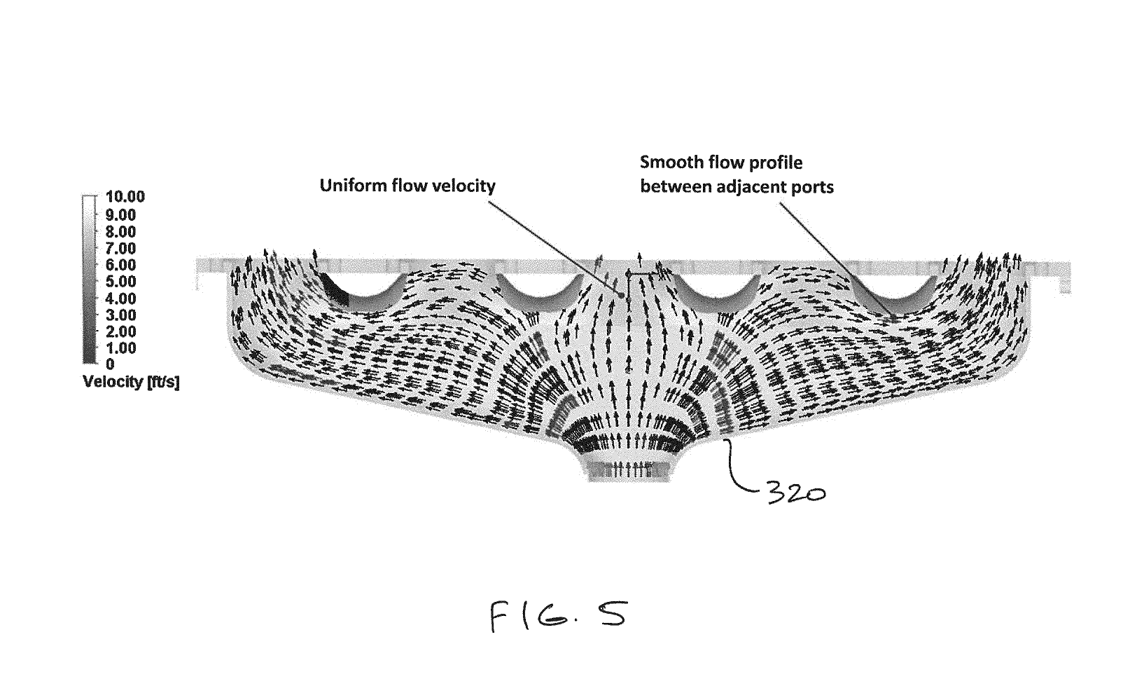

Referring now to FIGS. 4 and 5, computational fluid dynamics modeling of each suction manifold 120, 320 shows the shape of the suction manifold 320 of FIG. 3 to have much more beneficial flow characteristics than the conventional suction manifold 120 of FIGS. 1 and 2, including a more uniform velocity profile throughout, less reversing of the flow, fewer eddies, and less cross-talk between individual inlets. As shown in FIG. 4, flow through the conventional manifold 120 encounters obstacles and must negotiate tight corners due to the 90° bends. Further, the conventional manifold 120 results in inconsistent fluid velocity, eddy/reversing flow, and potentially cavitation. On the other hand, the suction manifold 320 of FIG. 3 provides a smoother flow profile with minimal obstacles and results in a more uniform fluid velocity.

As would be understood by persons skilled in the art, it is desirable to maintain the fluid velocity through the manifold 320 and into the pump cylinders within a desired range that is greater than a fallout velocity where proppant material (e.g., sand) falls out of suspension with the fluid and less than an erosional velocity that overdrives the piping system and causes excess erosion and risk of cavitation. That is, when fluid flow through the manifold 320 and into the pump cylinders is too low, the sand falls out. When fluid flow is too fast, it overdrives the piping system and causes excess erosion and risk of cavitation.

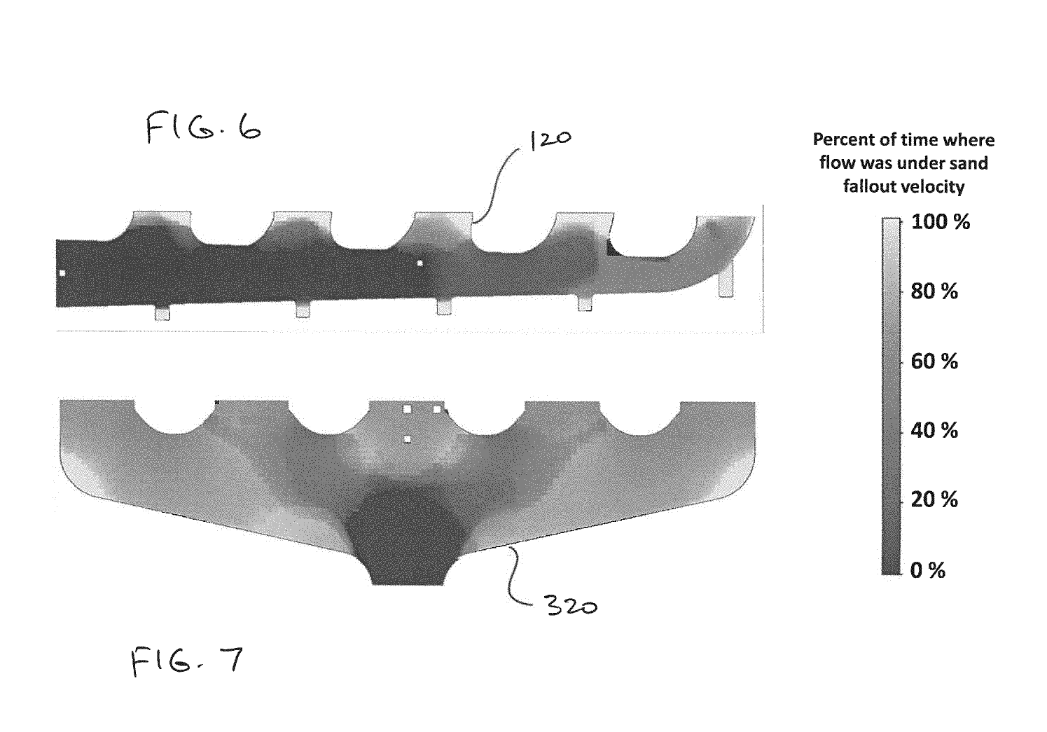

Referring to FIGS. 6 and 7, computational fluid dynamics modeling of each suction manifold 120, 320 shows a comparison of the percent of time where fluid flow through the suction manifold is below a desired sand fallout velocity at various regions of the suction manifold. As illustrated, the suction manifold 320 reduces the percentage of time that fluid flow at various regions is below the desired sand fallout velocity when compared to the conventional suction manifold 120.

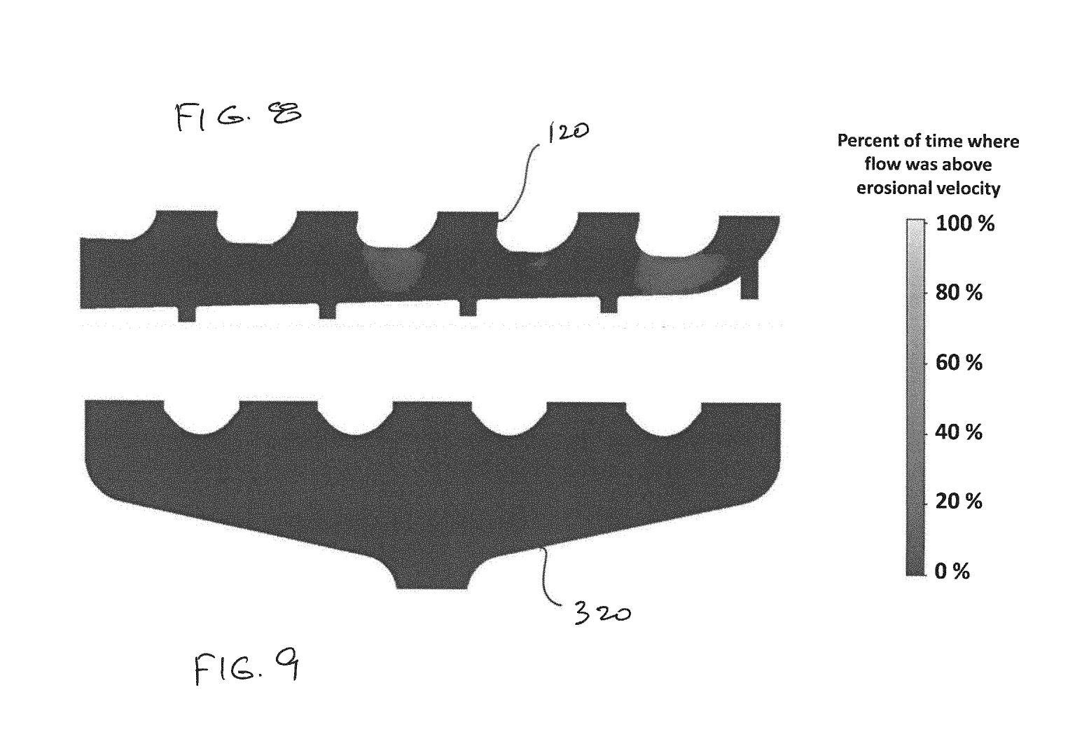

Referring to FIGS. 8 and 9, computational fluid dynamics modeling of each suction manifold 120, 320 shows a comparison of the percent of time where fluid flow through the suction manifold is above a desired erosional velocity at various regions of the suction manifold. As illustrated, the suction manifold 320 reduces the percentage of time that fluid flow at various regions is above the desired erosional velocity when compared to the conventional suction manifold 120.

Because of the above features, the suction manifold 320 delivers more uniform fluid velocity throughout, allowing unimpeded fluid flow to each of the pump's cylinders, thus reducing the risk of cavitation and pump damage. In accordance with the embodiment described above, the suction manifold 320 provides a smooth path for the fluid to follow, with a direct path from the inlet port 330 of the suction manifold 320 to each of the suction manifold ports 341, 342, 343, 344, 345, without discontinuities in velocity throughout the volume, or the need for the flow to reverse on itself as the different ports open and close.

Additional embodiments include any one of the embodiments described above, where one or more of its components, functionalities or structures is interchanged with, replaced by or augmented by one or more of the components, functionalities, or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A suction manifold for providing fluid flow to a pump for hydraulic fracturing, the suction manifold comprising:
an input port configured to receive a flow of fluid from a source;
a plurality of output ports configured to direct the flow of fluid to a plurality of corresponding cylinders of the pump; and
a chamber configured to direct the flow of fluid from the input port to the output ports,
wherein the input port is configured to direct the flow of fluid in a direction parallel to a direction in which the output ports direct the flow of fluid.

2. The suction manifold of claim 1, wherein the input port is on a first lateral side of the chamber and the output ports are on a second lateral side of the chamber opposite to the first lateral side.

3. The suction manifold of claim 1, wherein the output ports are spaced apart from one another in a second direction perpendicular to a flow direction through the input port.

4. The suction manifold of claim 1, wherein the chamber has a symmetrical configuration relative to a center of the input port in a second direction perpendicular to a flow direction through the input port.

5. The suction manifold of claim 1, wherein the output ports are arranged symmetrical relative to the center of the input port in a second direction perpendicular to the direction in which the output ports direct the flow of fluid.

6. A suction manifold for providing fluid flow to a pump for hydraulic fracturing, the suction manifold comprising:
an input port configured to receive a flow of fluid;
a chamber configured to receive the flow of fluid via the input port; and
a plurality of output ports configured to direct the flow of fluid from the chamber to a plurality of corresponding cylinders of the pump,
wherein the input port is on a first lateral side of the chamber and the output ports are on a second lateral side of the chamber opposite to the first lateral side,
wherein the output ports are spaced apart from one another in a first direction perpendicular to a flow direction through the input port, and
wherein the chamber has a symmetrical configuration in the first direction relative to a center of the input port.

7. The suction manifold of claim 6, wherein the output ports are arranged symmetrical relative to the center of the input port

8. The suction manifold of claim 6, wherein the input port is configured to direct the flow of fluid in a direction parallel to a direction in which the output ports direct the flow of fluid.

9. A pump for hydraulic fracturing comprising:
a high pressure pump power end supported on a mobile trailer having a width;
a pump fluid end operatively attached to the power end so as to provide a source of high pressure fluid for injection into an oil or gas well during a standard hydraulic fracking operation;
a suction manifold mounted to the fluid end, the suction manifold including an inlet port configured to receive a flow of fluid and a plurality of output ports configured to direct the flow of fluid to a plurality of corresponding cylinders of the pump power end,
wherein the input port and the output ports open in a direction of the width of the mobile trailer.

10. The pump of claim 9, wherein the suction manifold further comprises a chamber configured to direct the flow of fluid from the input port to the output ports.

11. The pump of claim 9, wherein the input port is configured to direct the flow of fluid in a direction parallel to a direction in which the output ports direct the flow of fluid.

12. The pump of claim 9, wherein the input port is on a first lateral side of the chamber and the output ports are on a second lateral side of the chamber opposite to the first lateral side.

13. The pump of claim 9, wherein the output ports are spaced apart from one another in a second direction perpendicular to a flow direction through the input port.

14. The pump of claim 9, wherein the chamber has a symmetrical configuration relative to a center of the input port in a second direction perpendicular to a flow direction through the input port.

15. The pump of claim 9, wherein the output ports are arranged symmetrical relative to the center of the input port in a second direction perpendicular to the direction in which the output ports direct the flow of fluid.
